(19) United States
(12) Patent Application Publication
(10) Pub. No.: US 2014/0111395 A1
(43) Pub. Date: Apr. 24, 2014

(54) Low-Profile Antenna-less RFID Tags and Integrated Circuit Wireless Transmission Apparatus

(71) Applicant: NDSU RESEARCH FOUNDATION, Fargo, ND (US)

(72) Inventors: Cherish Bauer-Reich, Fargo, ND (US); Layne Albert Berge, Rochester, MN (US)

(21) Appl. No.: 14/118,129

(22) PCT Filed: May 17, 2012
(86) PCT No.: PCT/US2012/038277

§ 371 Date: Dec. 4, 2013

Related U.S. Application Data
(60) Provisional application No. 61/486,806, filed on May 17, 2011.

(51) Int. Cl. H01Q 1/38; G06K 19/077

(52) U.S. Cl. CPC H01Q 1/38; G06K 19/07773
USPC 343/787; 235/492

(57) ABSTRACT

Disclosed embodiments include a low-profile, high-permeability antenna-less radio frequency identification (RFID) tag for use on large metal objects and other types of objects for which traditional RFID technologies will not work or do not work well. High-permeability materials are in contact with a metal surface, such as a metal container or metallic tape, diverting current into the tag integrated circuit (IC). This type of tag is essentially ‘antenna-less’ as it uses the ground plane or metallic object to excite currents through the IC. Tags using high-permeability materials in this manner are significantly thinner than those developed using other methods.

### STATEMENT REGARDING FEDERALLY SPONSORED RESEARCH OR DEVELOPMENT

This invention was made with Government support under Grant Number NO0189-10-C-Z055 awarded by the Naval Supply Systems Command, Department of Defense. The Government has certain rights in the invention.

### FIELD

Disclosed embodiments relate to radio-frequency identification (RFID) tags and wireless sensor or other integrated circuit (IC) transmission apparatus.

### BACKGROUND

In various environments and implementations, information from a remotely located IC must be transmitted wirelessly to another device. For example, RFID tags, certain temperature sensors and other types of sensors can require the transmission of data from an IC to a reader or other interfacing device. Transmission antennas are generally required to facilitate the transmission of data between the IC and the interfacing device.

RFID has become a standard way to track items both by the government and industry. RFID systems include an RFID tag and an RFID reader. The tag, which is typically placed on an object to be tracked, is made up of an IC and an antenna. The tracking is performed by the reader, an electronic device that is the interface between an antenna and a computer database. When a query is issued by the reader, the tag will respond with an identification code. The reader then passes the identification code to the computer, which accesses a database containing information about the object.

While there have been many types of tags available, they are not truly general purpose. That is, RFID tags are sensitive to the materials upon which they are applied and may not work well with very different materials. RFID systems are used in asset tracking, but general-purpose tags typically do not perform well on or near metal. Therefore, custom solutions for on-metal applications are common. Existing solutions for on-metal tags result in designs that are extremely thick.

A prime example of this is when attempting to tag containers made of metal or objects with liquids inside. Most tags that are meant to be applied to a surface of a box or crate will either not function or function poorly when placed on metal or on a container filled with liquid. There are many ways to work around this problem, but they usually involve tags that stand off from the surface. Such tags could easily be accidentally damaged or knocked off of the surface, making them impractical to use in many situations and requiring more material and special designs, increasing tag cost.

When designing an antenna for an RFID tag, a typical approach is to place the tag upon a dielectric with particular properties, such as having a relative permittivity of 4, and then trying to optimize the antenna so that the tag will work in that environment. This method is suitable for most packing and shipping materials. However, when faced with the prospect of tagging boxes full of metal or liquid-filled containers or even tagging the containers themselves, this particular method of tag design frequently does not produce desired results.

It is known that placing an antenna next to metal results in a decrease in the electric field as required by the boundary conditions. To a lesser extent, proximity to metal can detune the antenna such that the antenna is not delivering power optimally to the IC. Empirical measurements show that this results in a reduced link budget when a tag is placed on metal. Placement and changes in size of the metal object can shift the resonance frequency of the antenna. Also, curvature of the metal surface can affect readability of the tags. Further, the traditional approach of a dipole or loop antenna, that is, omnidirectional antennas, often implemented because they can be read from many directions, typically do not work well near a metallic object.

Prior research in antenna design has focused on several methods to mitigate the effects of the reduced field. The research has included devising ways to offset antennas from metallic objects using dielectrics, designing electromagnetic band-gap structures or metamaterials, and designing magnetic substrates. Another researched method involves designing antenna structures that can use the object as a ground plane, such as Planar Inverted-F Antennas (PIFAs) or patch antennas. These approaches have included techniques such as using a loop in a metal tag in one example, and splitting the ground plane in a foil-lined cigarette box and placing the IC between the halves in another example.

Many of the RFID tags that result from this prior work have drawbacks that make them less than ideal for various applications. Primarily, most of the tags have a thickness between 1 cm and 3 cm. Such thicknesses can make the tags less than ideal for some uses because they can be easily destroyed. They also may not comply with some regulations which require tags to be dual-use; that is, some regulations may require the tags to have appropriate information printed on them for visual identification. Some of the tags in the prior art also need to use a ground plane as part of their construction, and therefore don't work or work well in free space.

The above-described problems, which are discussed for exemplary purposes and need not be addressed by disclosed embodiments, are sometimes applicable in situations outside of RFID tags. Remote sensors, such as temperature sensors positioned on a metal container or a container filled with a fluid, can present the same design difficulties. What is needed in the art is an RFID tag, or more generally a power and transmission mechanism for an IC that functions well on metal and containers of liquid, but that is thin and is able to work in free space.

The discussion above is merely provided for general background information and is not intended to be used as an aid in determining the scope of the claimed subject matter.

### SUMMARY

Disclosed embodiments include a low-profile, high-permeability antenna-less radio frequency identification (RFID) tag for use on large metal objects and other types of objects for which traditional RFID technologies will not work. High-permeability materials are in contact with a metal surface, such as a metal container or metallic tape, diverting current into the tag integrated circuit (IC). This type of tag is essentially ‘antenna-less’ as it uses the ground plane or metallic object to excite currents through the IC. Tags using high-permeability materials in this manner are significantly thinner than those developed using other methods.

More generally, disclosed embodiments include wireless sensor or IC transmission apparatus which utilize a metallic surface and a high-permeability material to both provide power to the sensor or IC, and to transmit information using the metallic surface as an antenna.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIGS. 1-1 and 1-2 are perspective and side views, respectively, of an RFID tag or IC transmission apparatus.

FIG. 2 illustrates components of the apparatus shown in FIGS. 1-1 and 1-2, with a matching loop structure.

FIGS. 3-1 and 3-2 are side and top views, respectively, of an alternate RFID tag or IC transmission apparatus embodiment.

FIGS. 4-7 are tables illustrating high-permeability materials and/or results of experiments demonstrating disclosed concepts.

FIG. 8 is a side view illustration of the RFID tag or IC transmission apparatus embodiment shown in FIGS. 3-1 and 3-2, with the apparatus adhered to a metallic or non-metallic container having a fluid contained therein.

FIGS. 9 and 10 are side view illustrations of general purpose antenna structures in accordance with exemplary embodiments.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Because of the relatively large sizes and thicknesses of conventional RFID tags used with metal containers, disclosed concepts utilize the metal container or a metal ground plane to which the RFID tag is attached as the antenna. One method of doing so involves the creation of a physical gap in the ground plane. While this can be an effective way to tag some materials, it is not suitable for many objects, such as metal shipping containers.

In order to use the shipping container or the object itself as the antenna, it was recognized that either some form of impedance needs to be created which would divert electrical current and thereby cause the current to flow to the IC of the RFID tag instead of across the object ground plane, or larger currents need to be generated such that increased current flows into the structure and ultimately to the IC. However, a physical gap, which would create an open circuit and impede flow causing it to divert to the IC, would be destructive for many objects.

Disclosed concepts address the need for current to the IC by using configurations which are believed to generate larger currents on the object's surface, allowing increased current to flow to the IC. In the alternative, configurations which form an impedance across the object's surface and thereby divert current flow to the IC can also be used. Regardless of the particular employed mechanism (increased impedance or overall increased current generation), to increase current flow to the IC, disclosed concepts utilize high-permeability or magnetic materials on the surface of a metal shipping container or fluid container.

Permeability, in general, is defined to be the measure of the ability of a material to support the formation of a magnetic field within itself. Permeability shall be defined by the following:

μ=B/H

Where B is the magnetic flux density, H is the magnetic field intensity, and μ is a scalar representing the magnetic permeability of the material (that is, the ratio of the magnetic flux density to the magnetic field intensity).

Permeability, is further defined as the product of the relative permeability (μᵣ) and the permeability of free space (μ₀), or μ=μᵣ*μ₀. For the purposes of this specification, the term “high-permeability material” shall be defined to mean a material with a relative (electromagnetic) permeability greater than 1. Permittivity is a measure of the resistance that is encountered in forming an electric field in a medium.

Occasionally, the term “magnetic” or “magnetic material” may be used in this specification or in the references. For the purposes of this specification, the term “magnetic” shall mean “high-permeability”, and shall refer to a material with a high magnetic permeability as defined herein.

RFID tags must operate within defined frequency bands as established by regulatory authorities. For example, the experimental results described herein are for ultra-high frequency (UHF) RFID tags designed to operate between 900-925 MHz. However, disclosed embodiments and concepts are not limited to use in any particular frequency band, but instead can be applied more generally for different frequency bands and for different purposes.

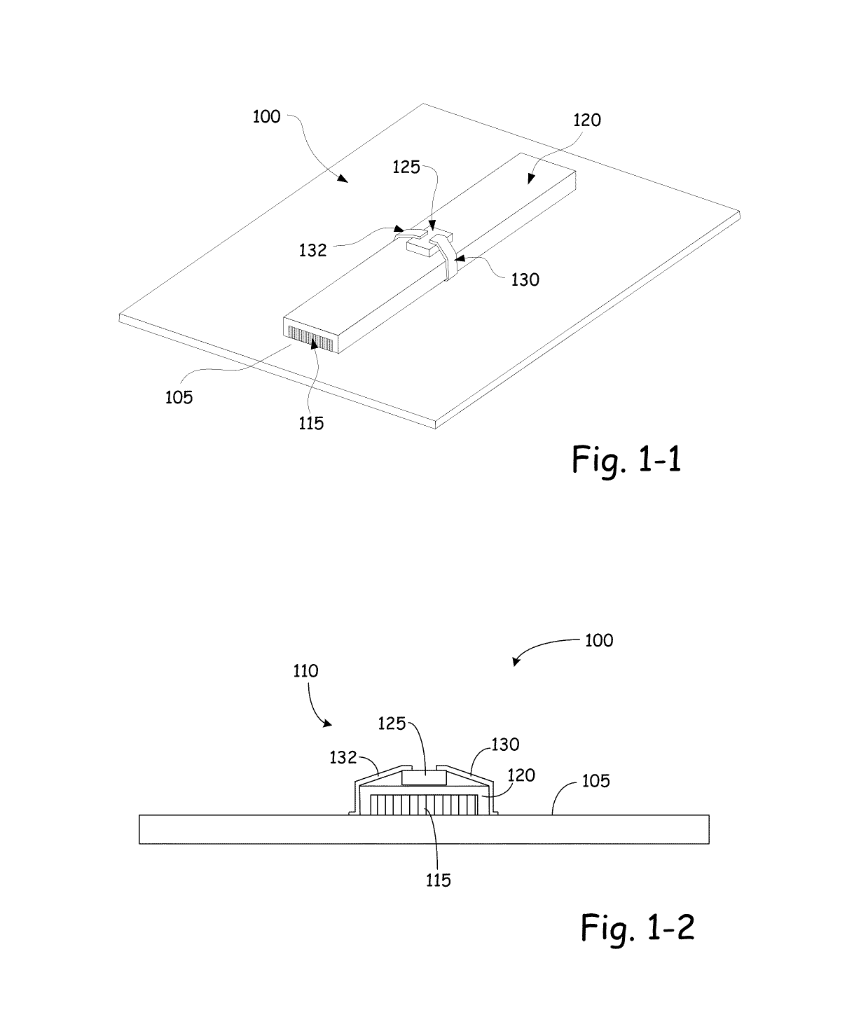

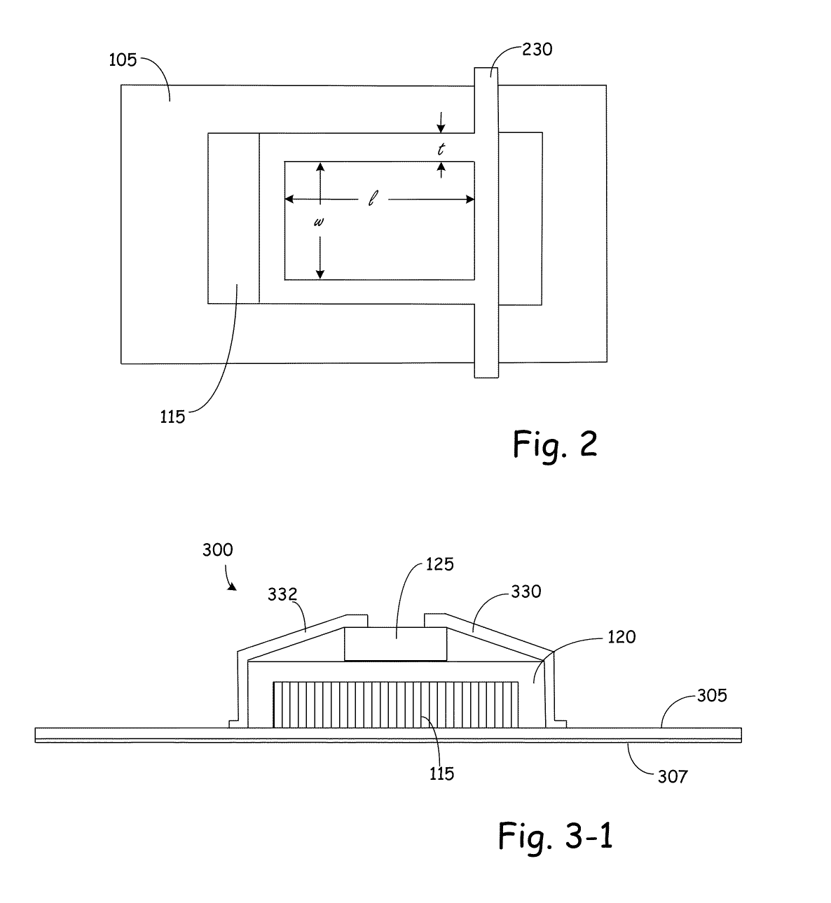

The analysis and results described herein were conducted using ANSYS HFSS (engineering simulation software) to simulate various high-permeability materials on an aluminum ground plane, which was intended to represent a metallic object on which the RFID tags can be used. The high-permeability material analyzed was a strip placed on the ground plane and covered on three sides (top and sides) with a thin layer of dielectric material. A port representing an RFID IC was placed on the top of the structure with metal bands passing from the port to the aluminum sheet below. This construction represents, for analysis, an RFID tag 100 shown in the perspective view of FIG. 1-1 and the side view of FIG. 1-2. RFID tag 100 includes a metallic surface 105 as the base, a tag body 110 with a core 115 of high-permeability material and a dielectric covering 120 on the top and sides of the high-permeability material, an RFID IC 125, and copper or other conductive material bands 130 and 132 electrically connecting the RFID IC 125 to the metallic surface 105 beneath.

After testing several commercially available high-permeability materials, it was discovered that different materials can be used to produce an “antenna-less” RFID tag or IC transmission apparatus. The term “antenna-less” in this context refers to configurations in which no separate antenna structure is required, but instead, a metallic ground plane or a metallic object on which the tag is positioned, functions as an antenna component. Thus, more robust RFID (or other sensor or IC) structures can be provided without the need for a separate antenna structure or a thick stand-off structure. Analysis conducted on these structures demonstrates that ferrite performs well as the high-permeability material. The peak realized gain seemed to increase both with permittivity and permeability, but the permeability had the larger effect.

Simulations were performed to determine ideal dimensions for an RFID tag. The subsequent evaluation utilizes the peak realized gain evaluated along the z-axis (the distance from RFID reader to the tag—a representation of how far away the tag can be read) for the optimization. Using a ferrite for the magnetic material, it was determined that in some exemplary embodiments and configurations, an optimal size (width×length×thickness) for the core 115 of high-permeability material was a strip that was 1 cm×8 cm×2 mm. In that exemplary embodiment, the optimal thickness for the dielectric covering material 120 was 0.4 mm. These optimal dimensions were for one particular tag embodiment, and disclosed embodiments are not limited to these particular dimensions or configurations.

A second round of simulations was performed to identify an optimal loop matching structure for the antenna. FIG. 2 illustrates core 115 and metallic base 105 with a matching loop structure 230 in place of conductive bands 130 and 132 to electrically connect the RFID IC to the metallic surface 105. For illustrative purposes, some of the features shown in FIGS. 1-1 and 1-2 are omitted from FIG. 2. Using the dimensions given above, it was found in one exemplary embodiment that a loop with inner dimensions of 2.0 cm×8 mm (l×w) and a trace thickness t of 2 mm created a very close match to the IC. This is provided as an example only, as different structures with a different IC can have different optimal loop structures and dimensions.

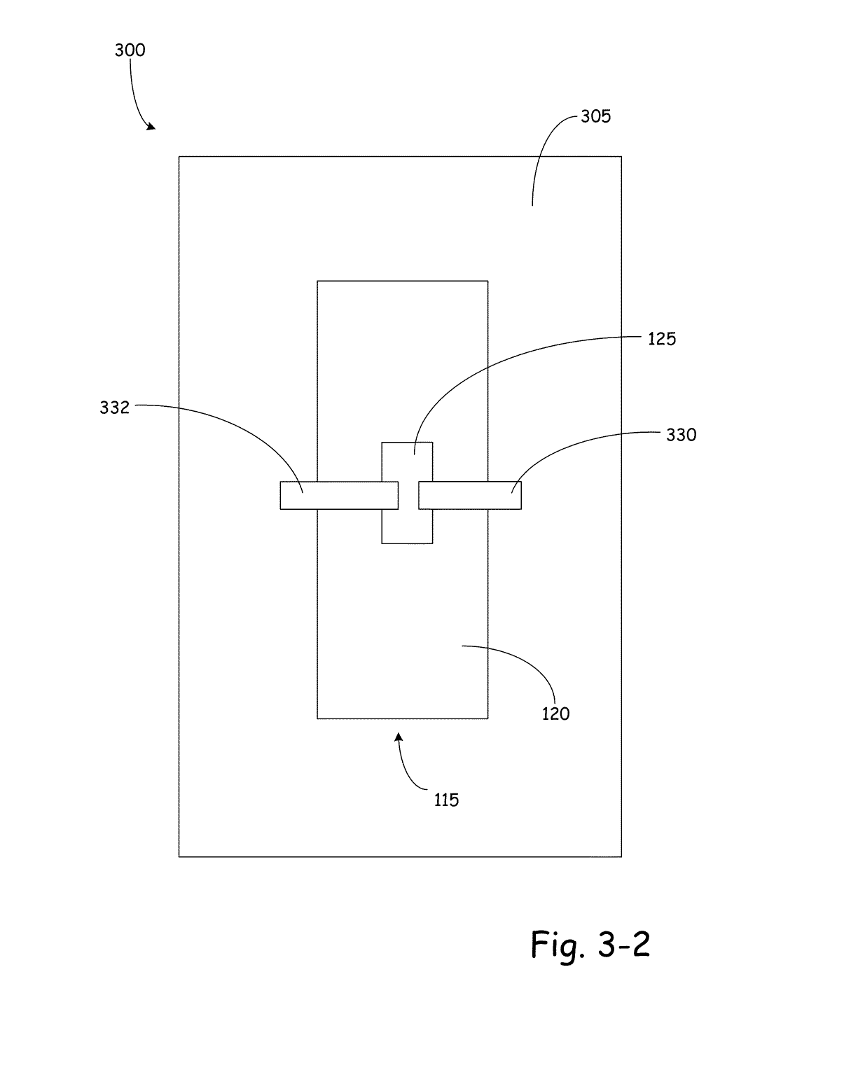

To construct tags for testing purposes, deviations were made from the simulated model having the core 115 of high-permeability material formed on a metallic surface 105 of a container. As shown in the side and top views of FIGS. 3-1 and 3-2, the constructed tags 300 result in a second useful embodiment in which the ferrite material (core 115) was placed on a piece of copper tape 305 having a conductive adhesive 307 which allows the tag 300 to be adhered to the surface of an object while establishing electrical contact with the surface. To form dielectric material 120, the ferrite was then coated with a latex dipping material on all sides except the side in contact with the copper tape. Initially, loop structures were removed, and the ends of the loop were soldered to the copper tape. The resulting electrical connection structure is represented by conductors 330 and 332 connected between IC 125 and copper tape 305.

Several tag variations were constructed to explore issues such as magnetic material properties, addition or subtraction of copper tape, and performance on and off metal and water. For comparison, tags made from FR4 (glass reinforced epoxy laminate sheets often used as substrates for electronic circuit boards) were also evaluated in place of the ferrite to validate that the ferrite was generating increased current flow from the metal object and that the behavior was not strictly due to the copper tape.

Evaluation of the tags was performed by measuring maximum read distance to the reader at a constant power level. This is mathematically equivalent to the minimum power test often used to evaluated RFID tags.

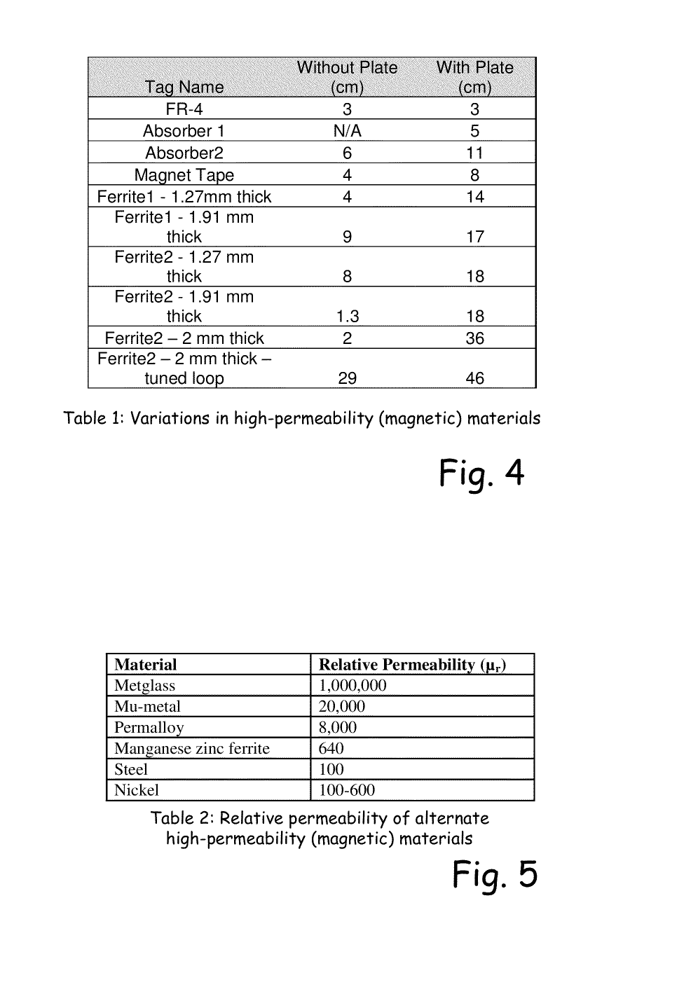

The first tests performed were meant to validate simulation. Initially, several different magnetic materials were tested in the configuration discussed above. Materials tested included five variations of FR-4, ferrite tiles, magnet strips, and absorber material. The FR-4 was used in place of the ferrite as a control. The Ferritel and Ferrite2 materials are HP and MP ferrite plates produced by Laird Technologies. The materials and read ranges are shown Table 1 included at FIG. 4.

The tags were measured in free space and then attached to an aluminum plate. The plate was 48.4 cm×33.7 cm×0.6 cm. The dimensions for all magnetic materials were approximately 1 cm wide by 8 cm long, except for the Ferrite2/long and Ferrite2/wide tags. The magnetic materials were covered with a thin layer of latex dipping compound.

The absorber materials (lossy material that absorbs electrical energy) and magnetic tape provided a small read range that was marginally better than the FR-4 tag. However, they did not perform as well as the ferrite materials. In general, the second ferrite material provided a better performing antenna than the first ferrite material. The optimum ferrite dimensions were the same as predicted using the simulation tools.

The Ferrite2-2 mm thick tag has additional readings shown with a ‘tuned loop designator’. These additional readings were generated by using a tuned loop structure with which to attach the IC, similar to that shown in FIG. 2. Thus, an appropriate matching network plays a large role in the performance of the tag.

While Table 1 illustrates test results for various high-permeability materials, disclosed embodiments are not limited to materials illustrated in Table 1. Instead, other high permeability materials can be used. For example, Table 2 included at FIG. 5 shows the relative permeability of alternate high-permeability materials which could be used in other embodiments.

In an effort to determine the effect of the copper tape in the performance of the antenna, antennas with a split in the ground plane were created, and the size of the copper tape was varied. The results of the tests are shown in Table 3 included at FIG. 6. The “no-center” tags have strips of copper tape on each side of the FR-4 or ferrite. This allows the FR-4 or ferrite to come in contact with the metal plate below the tag. The size of the ferrite was also varied with the overall size of the copper. The original Ferrite2-2 mm tag used a copper size of 10 cm×3.5 cm.

These results show that the copper is playing a role in the behavior of the antenna. Primarily, it indicates that the copper must be of a large enough size that it either couples to or overrides the effect of the metal ground plate below. However, the copper does not need to be between the metal plate and magnetic material for the antenna to work with a ground plane. The biggest difference in this configuration is that it will work significantly better in free space.

As a final test, the “Ferrite 2-2 mm” thick tag and the “Ferrite 2-no center tag” were tested on other materials. First, they were placed on a coffee can with a coating material to separate the antenna from the metal of the container. These tags were also tested on a water bottle. The results for both of these tests are shown in Table 4 included at FIG. 7.

While the Ferrite 2-2 mm tag performed worse in both scenarios, it is interesting to note that the tag lacking a center in the copper plane placed on the water bottle performed nearly as well as the Ferrite 2-2 mm on the metal plate. A likely explanation is that the water, having mobility, reacts to the field differently than metal and may enhance antenna performance.

Based on the results of tests described above, it can be seen that successful operation is achieved for disclosed embodiments of an on-metal RFID tag that incorporates a high-permeability material to generate current in the metal. The test results indicate the following non-limiting factors of some embodiments.

Tags made with ferrite tiles for the high-permeability material performed better than tags made with other ferro- or ferrimagnetic materials, including magnets and RF absorber material. Tags tended to perform better when placed on a ground plane than when in free space if there is a conductive copper surface between the magnetic material and the ground plane. Tags with a split copper plane tended to behave similarly to a tag with a unified copper plane on a metal plate, but the split copper plane increased performance in free space.

A decrease in performance occurred when the tag with the unified copper plane was placed on a painted (non-conductive) surface or on a container of water. However, the tags in these circumstances still functioned successfully. The split ground plane antenna performed very well on a container of water, but poorly on a painted metallic surface.

Finally, it was found that creating an appropriate matching structure for the IC will greatly enhance performance of the antenna.

As described above, some exemplary embodiments of an RFID tag (e.g., tag 100) place the high-permeability material 115 directly on a metal surface 105 ground plane. For example, this metal surface 105 can be a metal shipping or storage container of the type with which conventional RFID tags have not worked well or have required thick stand-off structures to separate the RFID tag components from the metal surface. Thus, disclosed embodiments provide opportunity for thinner RFID tags since spacing from the metal surface is not necessary. Further, disclosed embodiments provide more robust construction since a separate antenna structure is not required. Instead, these disclosed embodiments are able to utilize the metal surface as antenna components.

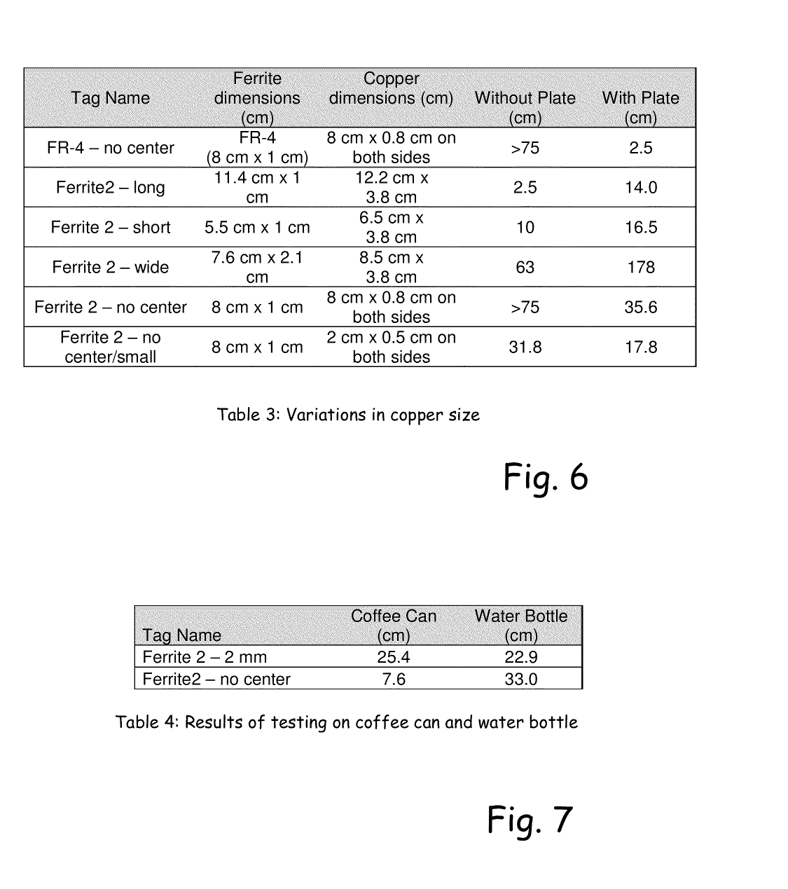

In other exemplary embodiments of an RFID tag (e.g., tag 300), the tag structure places the high-permeability material directly on a thin ground plane (e.g., copper tape) which can be adhered to the surface of a container. See for example FIG. 8 which illustrates conductive adhesive 307 of copper tape 305 adhering tag 300 to a surface of a container 705. In these embodiments, the copper tape or other thin ground plane forms part of the antenna structure. Such embodiments can be used with metal containers and with non-metal containers. Such embodiments also work well with containers housing a liquid, such as water, with which conventional RFID tags have not worked well. Tag 300 using copper tape or other adhering ground planes is not limited to use with liquids or non-metal containers.

Further, while exemplary embodiments have been described primarily with respect to examples in which IC 125 is an RFID IC, disclosed embodiments are not limited as such. In disclosed embodiments, IC 125 can be other types of ICs, for example ICs used as or in conjunction with sensors. In one embodiment, for example, IC 125 is a temperature sensor IC with a temperature dependent oscillator. The IC can be attached to a metal container or a container filled with liquid to monitor a temperature. An interfacing device similar to an RFID reader can then be used to interrogate the IC, which transmits its temperature data using the disclosed “antenna-less” structure. Other sensor types, and other types of ICs, are also encompassed within the disclosed concepts and embodiments.

The fact that this sensor can lay directly on the metal of a container (e.g., in the embodiment of FIGS. 1-1 and 1-2), or in very close proximity to the metal of a container when using a metallic tape as the securing mechanism and ground plane (e.g., in the embodiment of FIGS. 3-1, 3-2 and 8), provides advantages in monitoring the temperature of the container and/or the contents of the container. The requirement of many conventional RFID tags or similar structures, that they be distanced from the metal container surface, prevents accurate temperature measurement. Most conventional RFID tags or similar structures used as sensors are therefore measuring the surrounding environment and assuming that the ambient conditions are the same as the object on which it is mounted on. A tag that utilizes a spacer to function on metal doesn't have the tag directly on the surface and therefore cannot measure the temperature of the surface. Conventional tags used on metal surfaces have frequently been encapsulated, as well as spaced away from the metal, and therefore parameters to be measured (e.g., the metal temperature) can be distorted by the interference of the spacer or encapsulant. Because of the fact disclosed embodiments can lay directly on the metal, the conductors (e.g., 130/132 and 330/332) down to the surface act as thermally probes and the temperature can be measured directly.

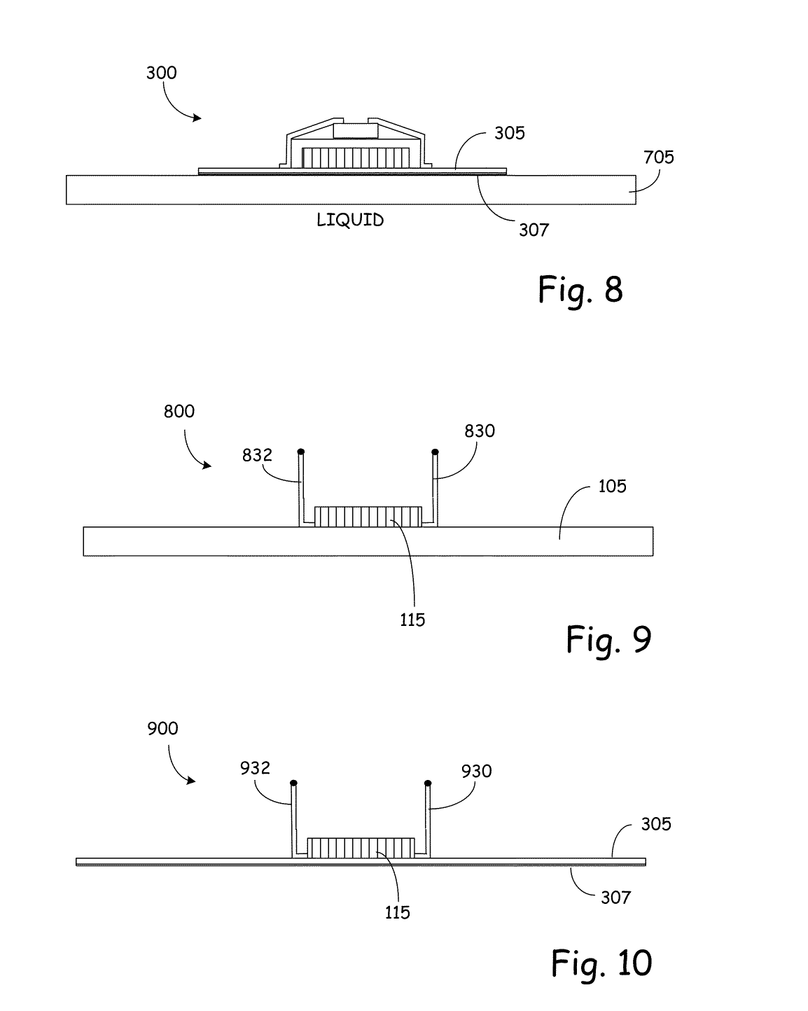

Also, while exemplary embodiments have been described with reference to structures that include an IC, the disclosed concepts can be more generally extended for other uses of the high-permeability antenna structure. For example, referring to FIG. 9, shown is a general purpose antenna structure 800 with features similar to those of RFID tag 100. As such, this structure includes high-permeability material 115 positioned in contact with a metallic surface 105. Feed structures 830 and 832 attach to the metallic surface 105 on either side of the high-permeability material, turning the metallic surface into an antenna for whatever device or system is to be electrically coupled to conductive feed structures 830 and 832. As a general-purpose antenna, this device would not require an IC, straps to create electrical continuity between the metallic surface and an IC, or a dielectric covering over the high-permeability material. FIG. 10 illustrates a similar general purpose antenna, but with conductive feed structures 930 and 932, as well as high-permeability material 115, attached to copper tape 305 or similar materials.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. For example, in various embodiments, different high-permeability materials can be used, different dielectric structures and materials can be chosen, and different conductive connections, loops structures, etc., can be used. Other examples of modifications of the disclosed concepts are also possible, without departing from the scope of the disclosed concepts.

What is claimed is:

1. An antenna-less circuit transmission apparatus, comprising:
a metallic surface;
a body, comprising
a high-permeability material with a relative permeability greater than 1; and
a dielectric material;
wherein the dielectric material forms a thin coating on the high-permeability material, except for a first side of the high-permeability material, which is left uncoated;
wherein the first side of high-permeability material is in direct contact with the metallic surface;
a circuit located on a second side of the body and electrically isolated from the high-permeability material by the dielectric material; and
electrical conductors forming an electrical contact between the circuit and the metallic surface, wherein the electrical conductors are isolated from the high-permeability material of the body by the dielectric material, and wherein the metallic surface functions as an antenna for the circuit.

2. The antenna-less circuit transmission apparatus of claim 1, wherein the apparatus is an antenna-less radio-frequency identification (RFID) tag and the circuit is an integrated circuit (IC) storing RFID information to be transmitted through the metallic surface, the IC being powered by electrical current received from the metallic surface through the electrical conductors.

3. The antenna-less circuit transmission apparatus of claim 2, wherein the metallic surface comprises a metallic container on which the RFID tag is positioned.

4. The antenna-less circuit transmission apparatus of claim 2, wherein the metallic surface comprises a section of metallic tape having a conductive adhesive which adheres the RFID tag to an object on which the RFID tag is to be positioned.

5. The antenna-less circuit transmission apparatus of claim 4, wherein the metallic tape comprises copper tape.

6. The antenna-less circuit transmission apparatus of claim 1, wherein the electrical conductors comprise a conductive matching loop structure.

7. The antenna-less circuit transmission apparatus of claim 1, wherein the electrical conductors comprise conducting metal bands.

8. The antenna-less circuit transmission apparatus of claim 1, wherein the high-permeability material comprises a ferrite material.

9. The antenna-less circuit transmission apparatus of claim 1, wherein the circuit is a sensor integrated circuit (IC) which generates data indicative of a sensed parameter, the sensor IC being powered by electrical current received from the metallic surface through the electrical conductors, and the sensor IC transmitting the data indicative of the sensed parameter through the metallic surface.

10. The antenna-less circuit transmission apparatus of claim 9, wherein the sensor IC is a temperature sensor IC.

11. An antenna-less transmission apparatus, comprising:
a metallic surface;
a body, comprising:
a high-permeability material, having a relative permeability greater than 1, positioned in contact with the metallic surface; and
a dielectric material forming a thin coating on the high-permeability material;
first and second conductors formed on sides of the high-permeability material and electrically connected to the metallic surface to electrically connect a circuit to the metallic surface such that the metallic surface functions as an antenna for the circuit.

12. The antenna-less transmission apparatus of claim 11, and further comprising a radio-frequency identification (RFID) circuit formed on the body and electrically isolated from the high-permeability material by the dielectric material, the RFID circuit being electrically connected to the first and second conductors to power the RFID circuit with electrical current received from the metallic surface and to transmit RFID information through the metallic surface.

13. The antenna-less transmission apparatus of claim 12, wherein the metallic surface comprises at least one of a metallic container on which the antenna-less transmission apparatus is positioned and a section of metallic tape.

14. The antenna-less transmission apparatus of claim 11, wherein the a high-permeability material of the body comprises a ferrite material.

15. The antenna-less transmission apparatus of claim 11, and further comprising a sensor circuit formed on the body and electrically isolated from the high-permeability material by the dielectric material, the sensor circuit being electrically connected to the first and second conductors to power the sensor circuit with electrical current received from the metallic surface and to transmit sensed information through the metallic surface.
